(19) United States
(12) Patent Application Publication
(10) Pub. No.: US 2008/0224081 A1
(43) Pub. Date: Sep. 18, 2008

(54) Valve Assembly

(75) Inventors: Koji Miyazaki, Amagasaki (JP); Kouichi Kaminaga, Amagasaki (JP); Kouichi Saji, Amagasaki (JP)

Correspondence Address: William L. Androlia;Quinn Emanuel Urquhart Oliver & Hedges, LLP, 10th Floor, 865 S. Figueroa Street, Los Angeles, CA, 90007, US

(73) Assignee: Neriki Valve Co. Ltd.

(21) Appl. No.: 10/583,885

(22) PCT Filed: Dec. 14, 2004
(86) PCT No.: PCT/JP2004/018644

§ 371 Date: Jun. 21, 2006

(30) Foreign Application Priority Data
Dec. 16, 2003 (JP) 2003-432828

(51) Int. Cl. F16K 7/12; F16K 7/16; F16K 1/32

(52) U.S. Cl. 251/331; 251/335.2; 137/863; 251/359

(57) ABSTRACT

The present invention has an object to improve the flow property so as to increase the gas flow amount, to inhibit the gas from staying within a valve chamber, and to enhance the gas-replacement property such as evacuation performance and purge performance.

A housing (2) is provided with a first flow passage (7), a valve chamber (9) of a shut-off valve (8) and a second flow passage (10) in the mentioned order. A diaphragm (13) is arranged so that it hermetically covers the valve chamber (9). The first flow passage (7) has an inner end opened into an inner surface of the valve chamber (9) to which a mid portion of the diaphragm (13) is opposed. A valve seat (15) is formed around this opening. The shut-off valve (8) is opened and closed by allowing the diaphragm (13) to approach and separate from the valve seat (15). A groove portion (18) is formed in the inner surface of the valve chamber (9) around the valve seat (15). A groove outlet/inlet (19) which communicates with the second flow passage (10) is opened into the groove portion (18) in an area larger than a circle having a diameter of a groove width (w). The second flow passage (10) communicates with the valve chamber (9) through the groove outlet/inlet (19) and the groove portion (18) in the mentioned order.

### TECHNICAL FIELD

The present invention concerns a valve assembly used for cylinder valves or the like and more particularly relates to a valve assembly of a structure suitable for a valve assembly which is attached to a gas cylinder storing and supplying semi-conductor material gas employed in the semi-conductor industry as well as purge gas, standard gas, carrier gas or the like high-purity gas and of being excellent in the flow property and the gas-replacement property.

### BACKGROUND ART

The gas to be used during the process of producing semi-conductors requires high-purity and high-cleanliness. The presence of particles, oxygen, moisture or the like in the gas causes such problems as bad device property and reduction of yield of the product attributable to the oxidation and metal pollution.

Generally, when attaching a gas cylinder to a semi-conductor production equipment and to a high-purity gas supply installation, the connection portion of the valve assembly is exposed to the air. Therefore, the air is contaminated into a space between this connection portion and a piping for attaching the gas installation. The air contaminated is removed by purging with an inert gas such as nitrogen and argon gas or through evacuation. However, should it be removed insufficiently, there is a likelihood that the residual impurities are contaminated into the gas cylinder.

For example, in the case of using gas having reactivity, if the oxygen, moisture or the like gas which constitutes the air is contaminated as residual impurities, it causes the change of gas concentration with the elapse of time, which in turn entailing the generation of impurities due to oxidation reaction and the corrosion of the metal surfaces at the gas-contact portions of the gas cylinder and of the valve assembly.

Further, when supplying the gas, there occurs pollution by the residual impurities from the gas supply installation to the consumption equipment. The pollution at the time of gas supply exerts not only influence on the gas system but also appears as the reduction of the yield of the semi-conductor products and the failure of the electric property.

Besides, in the event that the gum-like deposit produced by the reaction with the above-mentioned impurities sediments on the inner surface of the valve chamber, it is likely to cause an operation failure of the shut-off valve.

As s conventional example of the valve assemblies used for the foregoing gas cylinder, there is a so-called diaphragm-type valve assembly 50 (for instance, see Patent Literature 1) which comprises a first flow passage 52, a valve chamber 54 of a shut-off valve 53 and a second flow passage 55 formed in the mentioned order within a housing 51 and hermetically covers the valve chamber 54 with a diaphragm 56. In this valve assembly 50, the first flow passage 52 has an inner end provided to open into the inner surface of the valve chamber 54 to which a mid portion of the diaphragm 56 opposes. This opening has a peripheral edge formed with a valve seat 57, which the valve seat 57 advances to and retreat from, thereby allowing this shut-off valve 53 to open and close.

The above-mentioned valve assembly 50 has only a member of an under surface of the diaphragm 56 brought into contact with the gas within the valve chamber 54 except for the inner surface of the valve chamber of the housing and therefore is of an extremely simple construction. Thus it is suitable for the case of handling high-purity gas such as semi-conductor process gas.

Patent Literature 1: U.S. Pat. No. 2,775,496

### DISCLOSURE OF THE INVENTION

### Problem the Invention Attempts to Solve

With the conventional valve assembly 50, gas flows between the opening at the inner end of the first flow passage 52 and the opening at the inner end of the second flow passage 55. In the event that the diaphragm 56 is largely separated from the openings at the inner ends of both the flow passages 52 and 55, the gas readily stays in the vicinity of the diaphragm 56 within the valve chamber 54. Further, upon attaching it to and detaching it from the gas installation, it is preferable to reduce the residual amount of gas within the valve chamber 54 as well as the flow amount of air into the valve chamber as much as possible. For these reasons, the valve chamber is formed to have a volume as small as possible. However, if the valve chamber 54 has a volume reduced by arranging the diaphragm 56 close to both of the flow passages 52 and 55, particularly at the valve-closing time, a narrow space 58 is formed on the side opposite to the opening at the inner end of the second flow passage 55 with the valve seat 57 interposed therebetween. There occurs a problem that the gas readily stays in this narrow space 58. This requires repeating the evacuation and the operation of purging with inert gas many times, which makes the operation of replacing the gas within the valve chamber complicated and takes time.

Further, as shown in FIG. 11, the opening at the inner end of the first flow passage 52 is provided almost at the mid portion of the valve chamber 54 when seen in plan and the opening at the inner end of the second flow passage 55 is provided between a periphery of the valve seat 57 and a peripheral edge of the valve chamber 54. Accordingly, it is not easy to enlarge the inner diameters of both the flow passages 52 and 55. For example, each of the flow passages has an inner diameter limited to about one fifth (⅕) the diameter of the diaphragm. Thus it is not easy to increase the flow amount of the gas which flows via both the flow passages to result in taking lots of time for the filling work or the like.

The present invention has a technical object to provide a valve assembly able to solve the above-mentioned problems, which can improve the flow property to increase the flow amount of gas and besides can inhibit the gas from staying within the valve chamber, and has improved the gas-replacement property such as the evacuation performance and the purging performance.

### Means for Solving the Problem

In order to solve the above problems, the present invention is constructed as follows, for example, if an embodiment of the present invention is explained with reference to FIGS. 1 to 9.

The present invention relates to a valve assembly. This valve assembly has a housing 2 in which a first flow passage 7, a valve chamber 9 of a shut-off valve 8 and a second flow passage 10, 23 are formed in the mentioned order. A diaphragm 13 is arranged so that it hermetically covers the valve chamber 9. The first flow passage 7 has an inner end provided to open into an inner surface of the valve chamber that a mid portion of the diaphragm 13 faces. A valve seat 15 is formed around this opening. The shut-off valve 8 is opened and closed by allowing the diaphragm 13 to approach and separate from the valve seat 15. The inner surface of the valve chamber has a groove portion 18 formed around the valve seat 15. The groove portion 18 is opened to provide an outlet/inlet 19 having an area larger than a circle having a diameter of a groove width (w). The second flow passage 10, 23 is communicated with the valve chamber 9 through the outlet/inlet 19 and the groove portion 18 in the mentioned order.

The groove outlet/inlet formed in the groove portion is opened in an area larger than the circle having the diameter of the groove width, so that it has a flow resistance smaller than that of the conventional art. Thus the gas flowed into the valve chamber from the first flow passage flows smoothly through the groove portion to be guided into the second flow passage from the groove outlet/inlet. On the contrary, the gas flowed from the second flow passage smoothly passes through the groove portion via the groove outlet/inlet and then is guided from the valve chamber to the first flow passage.

Although it is possible to elongate the groove outlet/inlet along a longitudinal direction of the groove portion to a groove bottom surface, if it is formed along a groove side surface or spans between the groove side surface and the groove bottom surface, it can be easily opened to have a large area without being restricted by the groove width. Therefore, it is preferable.

The second flow passage can have at least an inner end portion provided so as to incline with respect to an axis of the first flow passage. In this case, the gas which moves toward the groove bottom surface within the groove portion is guided smoothly toward the second flow passage. Thus this is preferable.

In the event that the groove portion has its depth formed evenly, it offers an advantage to facilitate the formation of the groove portion. However, the groove bottom surface may be formed so that it increases its depth toward the groove outlet/inlet. In this case, the gas which has reached the groove bottom surface smoothly flows into the second flow passage via the groove outlet/inlet. Therefore this is also preferable.

Although the groove portion may be formed at a part of the periphery of the valve seat in the shape of an arc, if it is annularly formed so that it surrounds the whole valve seat, the entire space within the valve chamber communicates with the second flow passage well through this groove portion. Therefore, this is more preferable.

The second flow passage may be communicated from a normal-line direction of the groove portion, namely a direction perpendicular to the groove side surface when seen in plan. However, for example, as shown in FIG. 7, when it is communicated from a direction tangent to the groove portion, the gas which has flowed from the second flow passage side is guided into the valve chamber while circulating within the groove portion and the gas within the valve chamber is involved in this flowed-in gas to be replaced favorably. Thus this is preferable.

It is sufficient if the groove portion has the largest depth able to increase the area of the opening provided in the groove portion. For instance, it is formed in the dimension of not less than 30% of the groove width, preferably not less than 50% thereof and more preferably at least equal to the groove width.

In addition, the largest depth of the groove portion is preferably set to a dimension at least equal to the minimum inner diameter of the first flow passage.

### EFFECT OF THE INVENTION

As the invention is constructed and functions as mentioned above, it offers the following effects.

The groove outlet/inlet formed in the groove portion has an opening the area of which is larger than that of a circle having a diameter of the groove width and beside the second flow passage communicates with the valve chamber through the groove outlet/inlet of this large opening. Consequently, this second flow passage can have its inner diameter increased without undergoing the limitation by the size of the valve chamber, the diameter of the diaphragm and the like. As a result, it is possible to reduce the flow resistance of the gas which flows between the valve chamber and the second flow passage without enlarging the valve assembly so as to enhance the flow performance with the result of being able to increase the gas flow amount. Thus, for instance, the gas can be filled within a short period of time to increase the efficiency of the gas filling work.

Since the groove portion is formed in a wide region around the valve seat, even if the groove width is somewhat decreased, this groove portion can have a flow passage the sectional area of which is sufficiently wide. Then the reduction of the groove width can increase the inner diameter of the first flow passage, which in turn results in the possibility of decreasing the flow resistance of the first flow passage as well. This further enhances the flow performance with the result of being able to more increase the flow amount of the gas which flows through both the flow passages.

The taken-out gas as well as the filling gas smoothly flows through the groove portion and beside the groove portion is formed around the valve seat. Consequently, even if the diaphragm is provided close to the inner surface of the valve chamber, the gas flows without staying in the valve chamber and this groove portion. As a result, in the case where the gas within the valve chamber is replaced with inert gas, the gas within the valve chamber is evacuated well. In addition, the purge gas flows into the valve chamber favorably to result in the possibility of enhancing the gas-replacement property within the valve chamber. Accordingly, for example, it is possible to reduce the time for preparation of the purging work or the like until the gas cylinder is attached to the semi-conductor installation and the high-purity gas supply equipment so as to use the gas actually and therefore to enhance the working efficiency.

### BRIEF DESCRIPTION OF THE DRAWINGS

FIG. 1 is a vertical sectional view of a valve assembly which shows an embodiment of the present invention.

FIG. 2 is a broken perspective view of the vicinity of the valve chamber according to the embodiment.

FIG. 3 is a plan view, in cross section, of the vicinity of the valve chamber according to the embodiment.

FIG. 4 is a comparison graph which shows the measurement result of the gas-replacement property.

FIG. 5 is a vertical sectional view of the vicinity of the valve chamber according to a first modification.

FIG. 6 is a vertical sectional view of the vicinity of the valve chamber according to a second modification.

FIG. 7 is a plan view, in cross section, of the vicinity of the valve chamber according to a third modification.

FIG. 8 is a plan view, in cross section, of the vicinity of the valve chamber according to a fourth modification.

FIG. 9 is a plan view, in cross section, of the vicinity of the valve chamber according to a fifth modification.

FIG. 10 is a partly broken elevational view of an essential portion of a valve assembly which shows a conventional technique.

FIG. 11 is a plan view, in cross section, of the vicinity of the valve chamber according to the conventional technique.

### EXPLANATION OF NUMERALS

1 . . . valve assembly
2 . . . housing
7 . . . first flow passage (gas inlet hole)
8 . . . shut-off valve
9 . . . valve chamber
10 . . . second flow passage (gas outlet hole)
13 . . . diaphragm
15 . . . valve seat
18 . . . groove portion
19 . . . groove outlet/inlet
20 . . . groove side surface
21 . . . groove bottom surface
22 . . . axis of the first flow passage (gas inlet hole)
23 . . . second flow passage (communication hole)
d . . . groove depth
w . . . groove width

### MOST PREFERRED EMBODIMENT FOR PUTTING THE INVENTION INTO PRACTICE

Hereafter, an explanation is given for an embodiment of the present invention based on the drawings.

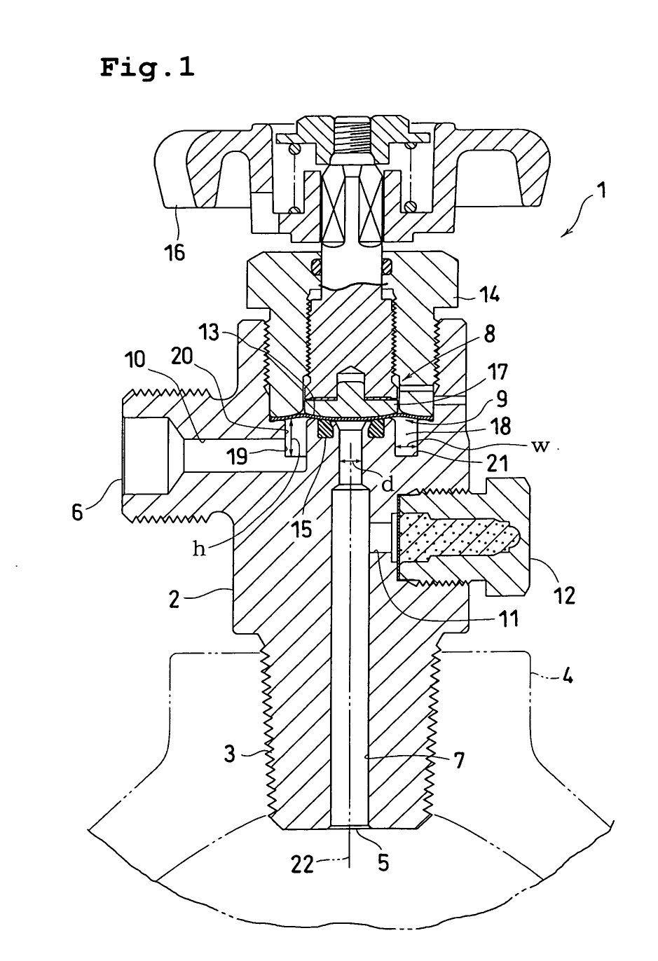

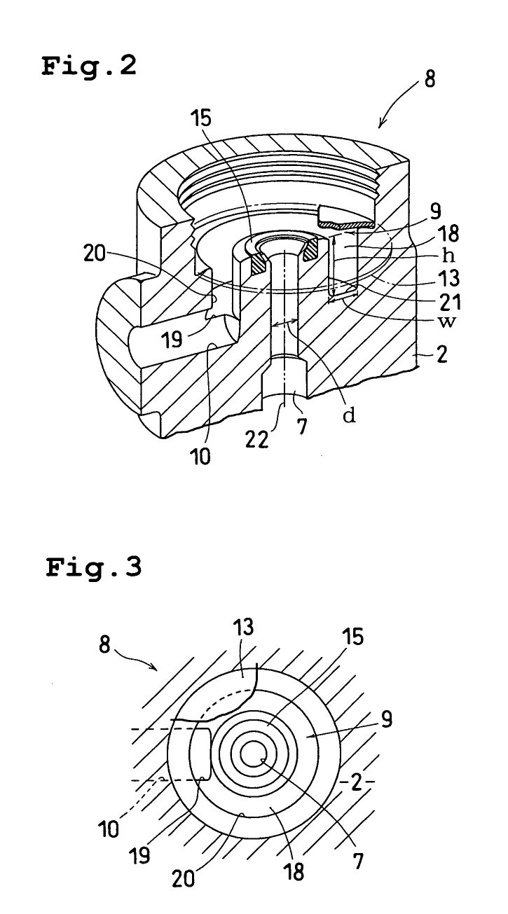

FIGS. 1 to 3 shows an embodiment of a valve assembly according to the present invention. FIG. 1 is a vertical sectional view of the valve assembly. FIG. 2 is a broken perspective view of the vicinity of a valve chamber. FIG. 3 is a plan view, in cross section, of the valve chamber.

As shown in FIG. 1, this valve assembly 1 for gas cylinder comprises a housing 2 which has a lower portion formed with a threaded leg portion 3 to be fixed in fitting engagement with a mouthpiece for taking out gas of a gas cylinder 4. This threaded leg portion 3 has a under surface opened to provide a gas inlet 5 and the housing 2 has a mid-height portion horizontally opened to provide a gas outlet 6. The housing has an interior region provided with a gas inlet hole 7 as a first flow passage which extends from the gas inlet 5 to the gas outlet 6, a valve chamber 9 of a shut-off valve 8 and a gas outlet hole 10 as a second flow passage in the mentioned order. Branched from the gas inlet hole 7 is a gas relief hole 11 in which a safety valve 12 is provided.

The material of the housing is not limited to a particular material, but may be forged from, for example, brass, stainless steel, nickel alloy or the like and is manufactured by machining. Further, in order to reduce the influence of adsorbing the moisture or the like gas molecules and the particles to the surfaces which contact the gas and to improve the corrosion-resistance of the metal surface, the gas-contact surfaces are preferably subjected to the mechanical polishing, abrasive grain polishing, electropolishing, composite electropolishing, chemical polishing and composite chemical polishing.

There is arranged in the valve chamber 9 a metal diaphragm 13 made of stainless steel, nickel-base alloy, copper alloy or the like. This diaphragm 13 has a peripheral edge portion pushed and fixed to a peripheral wall of the valve chamber 9 by a valve closure 14. This diaphragm 13 hermetically covers an upper portion of the valve chamber 9. The valve chamber 9 has an inner surface opposed to a mid portion of the diaphragm 13, which is opened approximately at its mid portion to provide an inner end of the gas inlet 7. This opening has a periphery formed with a valve seat 15 made of fluorine resin or the like resilient member. According to the present invention, by taking the efficiency of removing moisture into consideration, it is possible to adopt an all-metal valve structure in which the valve seat is integrally formed with the housing 2, instead of the valve seat 15 formed from the resilient member.

An actuation chamber is formed above the diaphragm 13. This actuation chamber houses an intermediate transmission means 17 which is placed at a mid portion of an upper surface of the diaphragm 13. This intermediate transmission means 17 is interlockingly connected to an operation handle 16. When this intermediate transmission means 17 is pushed down by this operation handle 16, the diaphragm 13 is brought into valve-closing contact with the valve seat 15 against the upward force exerted by the gas pressure and the resilient repulsion of the diaphragm 13. On the other hand, when the pushing force to the intermediate transmission means 17 is cancelled, the mid side portion of the diaphragm 13 is resiliently returned to an upward convex shape, thereby allowing the gas inlet hole 7 to communicate with the valve chamber 9.

As shown in FIGS. 1 to 3, the valve chamber 9 has an inner surface formed with an annular groove portion 18 around the valve seat 15. This groove portion 18 is set to have a groove depth (h) larger than a groove width (w) as well as than an inner diameter (d) of the gas inlet hole 7. More specifically, this groove portion 18 is formed so deeply that it reaches the vicinity of a center of the gas outlet hole 10. A groove outlet/inlet 19 opened into the gas outlet hole 10 is formed so that it spans between the groove side surface 20 and the groove bottom surface 21. The opening of this groove outlet/inlet 19 has an area larger than a circle having a diameter of the groove width (w) as shown in FIG. 3. The gas outlet hole 10 communicates with the valve chamber 9 through the groove outlet/inlet 19 and the groove portion 18 in the mentioned order.

When taking out the stored gas from the gas cylinder 4, the operation handle 16 is operated to separate the diaphragm 13 from the valve seat 15, thereby enabling the gas stored within the gas cylinder 4 to flow from the gas inlet 5 into the valve chamber 9 via the gas inlet hole 7. The gas flowed into the gas chamber 9 spreads within the valve chamber 9 along the under surface of the diaphragm 13 to be guided into the groove portion 18 through which it smoothly flows and to be taken out of the gas outlet 6 through the groove outlet/inlet 19 and the gas outlet hole 10 in the mentioned order.

When filling gas into the gas cylinder 4, a gas filling device (not shown) is connected to the gas outlet 6 and the shut-off valve 8 is opened. The fresh gas supplied by the gas filling device flows into the groove portion 18 through the gas outlet 6, the gas outlet hole 10 and the groove outlet/inlet 19 in the mentioned order. After having flowed through the groove portion 18 smoothly, it flows into the valve chamber 9. The fresh gas which has flowed from this groove portion 18 into the valve chamber 9 flows along the under surface of the diaphragm 13 and is guided into the gas inlet hole 7 opened into the approximately mid portion of the valve chamber 9 and is filled from the gas inlet 5 into the gas cylinder 4 through the gas inlet hole 7.

In the case where the gas cylinder 4 is attached to, for example, a semi-conductor production equipment, the air residual in the valve chamber 9, the groove portion 18 and the gas outlet hole 10 is removed through purging by inert gas or evacuation. More specifically, with the shut-off valve 8 closed, an evacuation device (not shown) is connected to the gas outlet 6, thereby sucking and discharging the gas in the gas outlet hole 10, the groove portion 18 and the valve chamber 9. At this time, the valve chamber 9 has its interior region opposed to the annular groove portion 18 to result in having no narrow space. Thus the gas within the valve chamber and the like is efficiently sucked and discharged. Next, a purge-gas supply installation (not shown) is connected to the gas outlet 6 and then a purge gas which consists of inert gas such as nitrogen gas is supplied from the gas outlet hole 10 into the valve chamber 9 through the groove portion 18. Since there exists no narrow space in the valve chamber 9, the purge gas spreads to every corner of the valve chamber 9 and is mixed well with the gas, the particles and the like residual in the valve chamber 9 to be replaced with them. Thereafter, the evacuation treatment and the purge treatment are repeated to sufficiently remove oxygen, moisture and the like impurities contained in the air from the valve chamber 9, the groove portion 18 and the outlet hole 10 and then the semi-conductor production equipment or the like is connected to the gas outlet 6. Further, all the evacuation device, the purge-gas supply device and the like may be preliminarily connected to the gas outlet 6 through a switch-over valve or the like together with the semi-conductor production equipment and the like.

Next, as regards the gas-replacement performance of the valve assembly, we will explain the measured results while comparing the present invention with the conventional valve assembly.

(1) Evacuation Speed

A vacuum pump was connected to the gas outlet of the valve assembly and the period of time taken until the degree of vacuum reaches the 1 Pa (0.0075 Torr) was measured. As a result, although it took 908 seconds for the embodiment to arrive at a predetermined pressure, it took 1070 seconds for the conventional technique to reach the predetermined pressure. In consequence, the embodiment could reduce the time for evacuation by about 15% when compared with the conventional one in spite of the fact that the inner space increased due to the formation of the groove portion.

(2) Conductance of Valve (Cv Value)

A pressure difference of 6.9 KPa was provided between the front portion of the valve assembly and the rear portion thereof. Then the amount of the water (US gallon) at a temperature of about 15 degrees C. which flowed for 1 minute was measured. As a result, the Cv value was 0.40 in a direction of taking out gas and it was 0.35 in a direction of filling gas. On the other hand, as for the conventional technique, the Cv value was 0.20 in both of the gas taken-out direction and the gas filling direction. In consequence, the flow amount improved as much as 2 times that of the conventional technique in the gas taken-out direction and as much as 1.75 times that of the latter in the gas filling direction.

(3) Gas-Replacement Property

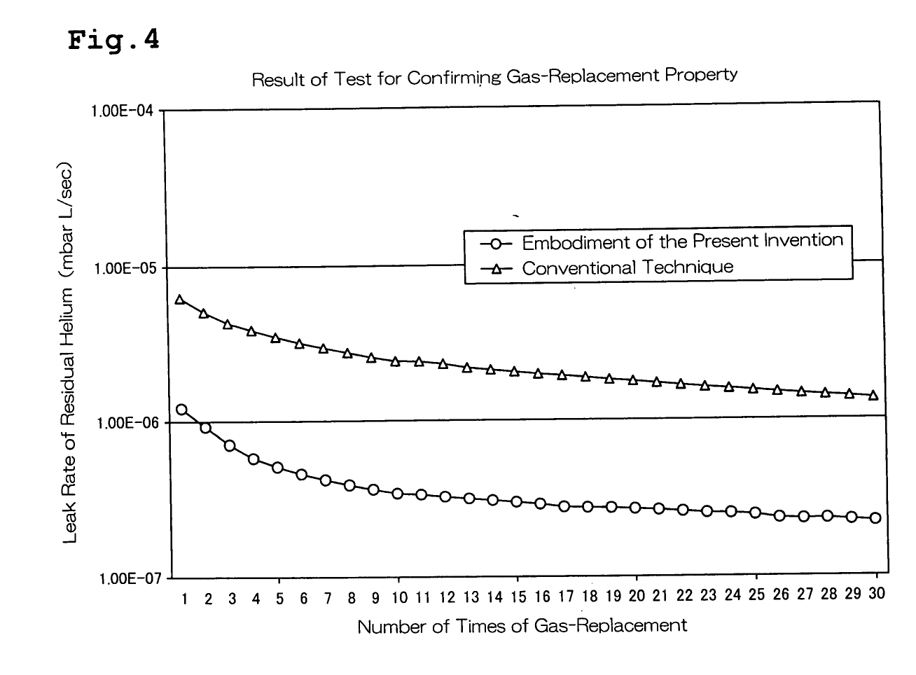

Helium gas was flowed into the valve assembly to saturate the gas outlet side with the helium and then the shut-off valve was closed. The purge treatment was effected by supplying nitrogen gas to the gas outlet and vacuuming. The number of repetition of this purge treatment was measured as well as the amount of helium gas (leak rate) residual on the gas outlet side The measured results are shown in the Comparison Graph of FIG. 4. Apparently from this measurement results, the valve assembly of the embodiment is excellent in the gas-replacement property because it suffices if the number of the repetition of the purge treatment is smaller than that of the conventional technique.

In the foregoing embodiment, the explanation was given for the case where the shut-off valve was opened and closed by the operation handle. Needless to say, the shut-off valve can be remotely opened and closed by using pressurized fluid and an electromagnetic device. The valve assembly of the present invention is not limited to the foregoing embodiment, but it can be modified to the following ones.

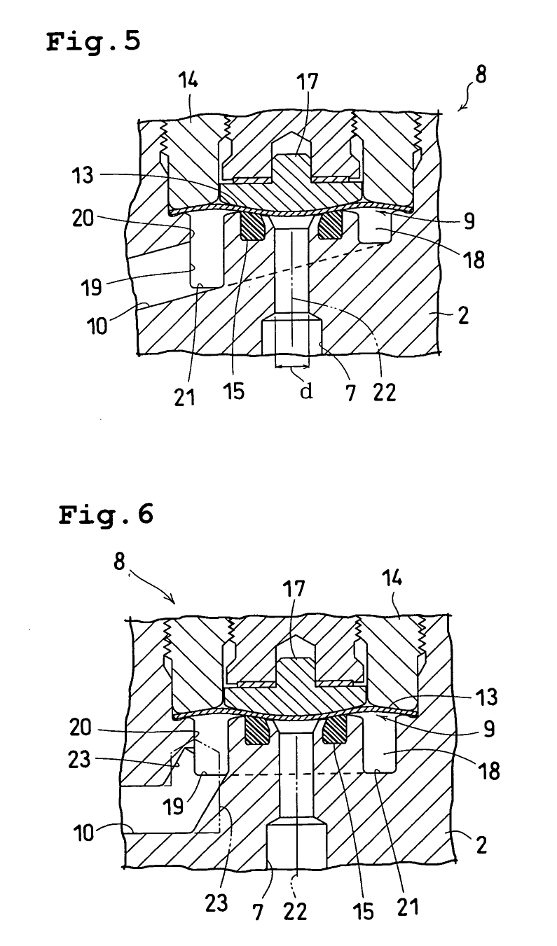

In a first modification shown in FIG. 5, the gas outlet hole 10 is inclined with respect to an axis 22 of the gas inlet hole 7 so that its inner end side approaches the valve chamber 9. Further, the groove portion 18 makes its bottom surface 21 so slant that it increases its depth toward the groove outlet/inlet 19. Owing to these constructions, the gas more smoothly flows between the groove portion 18 and the gas outlet hole 10.

Owing to the fact that the second flow passage which consists of the gas outlet hole 10 is formed linearly, the taken-out gas, the filling gas and the purge gas smoothly flow through this gas outlet hole. However, according to the present invention, the second flow passage may be curved. More specifically, in a second modification shown in FIG. 6, the second flow passage consists of a linear gas outlet hole 10 and a communication hole 23 which is inclined and connected to an inner end side thereof. This communication hole 23 is formed slant with respect to the axis 22 of the gas inlet hole 7. The groove outlet/inlet 19 formed in the groove portion 18 is opened into the communication hole 23. This communication hole 23 may be provided in parallel with the axis 22 of the gas inlet hole 7 as shown by an imaginary line in FIG. 6.

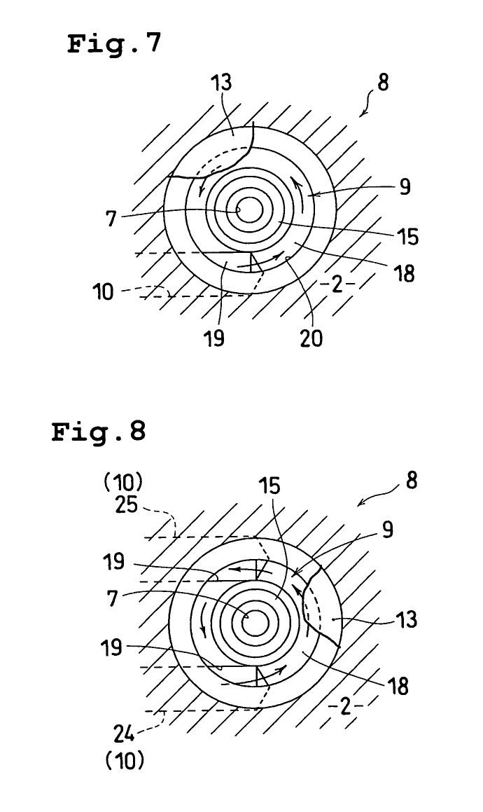

In the above-mentioned embodiment, the gas outlet hole 10 is connected to the groove portion 18 from the normal line, namely from a direction perpendicular to the groove side surface 20. On the other hand, in a third modification shown in FIG. 7, it is communicated with the groove portion 18 from a direction tangent to the groove portion 18 when seen in plan. When it is connected as such, the purge gas which has flowed in from the gas outlet hole 10 and then passed through the groove outlet/inlet 19 flows into the valve chamber 9 while circulating within the groove portion 18, to involve the gas within the valve chamber 9 with the result of being able to replace it favorably.

In a fourth modification shown in FIG. 8, two second flow passages 10, 10 are formed within the housing 2 and are connected to the groove portion 18, respectively from the tangent direction. When taking out the gas stored in the gas cylinder therefrom, both or either of the two second flow passages 10, 10 is used. On one hand, in the case of purging the groove portion 18 and the interior region of the valve chamber 9, while one of the second flow passages 10 is used to serve as a purge-gas filling passage 24 and is connected to the purge-gas supply installation, the other is employed to serve as an exhaust passage 25 and is connected to an evacuation device or the like. If constructed as above, the purge gas smoothly flows through the groove portion 18 and the interior region of the valve chamber 9 to result in efficient purging. Thus preferable.

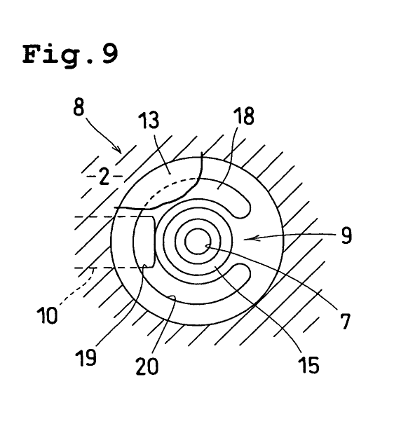

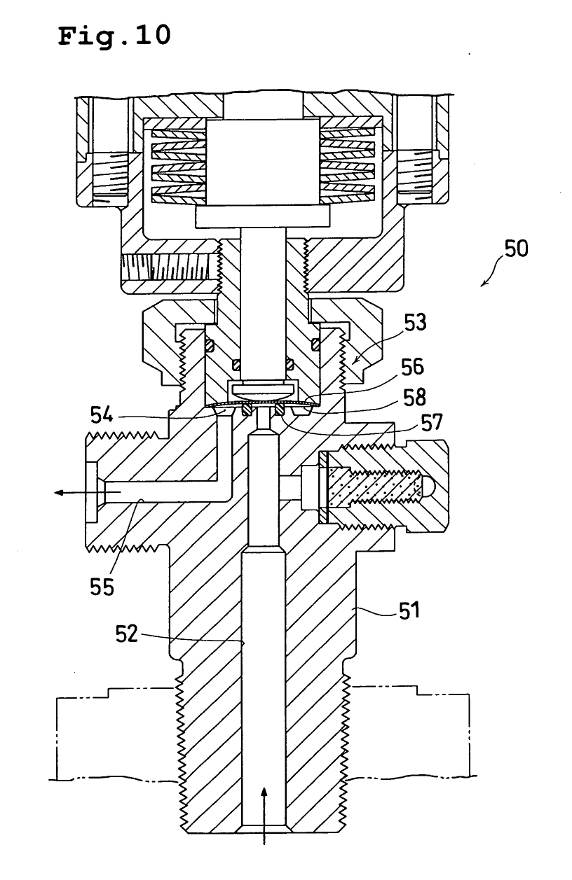

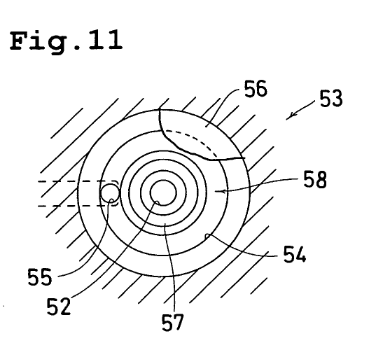

The groove portion 18 of the foregoing embodiment is formed annular when seen in plan, so that the space within the valve chamber around the valve seat 15 uniformly faces this groove portion 18 and therefore is preferable. However, according to the present invention, for example, like a fifth modification shown in FIG. 9, it is possible to form the groove portion 18 arcuate when seen in plan. Also in this case, since the taken-out gas and the filling gas smoothly pass through this wide groove portion 18, the fifth modification is excellent in flow property. Further, although a narrow space is formed at a position where the groove portion 18 is discontinued within the valve chamber 9, owing to the fact that the flow property at this groove portion 18 is excellent, in the case of replacing the gas within the valve chamber 9, the purge gas well flows into the valve chamber 9 and the gas in the narrow space is easily replaced.

### INDUSTRIAL AVAILABILITY

The valve assembly of the present invention is excellent in flow property and therefore is suitably used for the valve of the gas cylinder as well as the valve assembly of the other gas instrument. Besides, it is also excellent in gas-replacement property. Accordingly, it is particularly suitably used for the valve of the gas cylinder employed for the semi-conductor production equipment and the high-purity gas supply installation.

1: A valve assembly comprising a housing (2) in which a first flow passage (7), a valve chamber (9) of a shut-off valve (8) and a second flow passage (10, 23) are provided in the mentioned order,
a diaphragm (13) hermetically covering the valve chamber (9),
the first flow passage (7) having one end opened into an inner surface of the valve chamber (9) to which a mid portion of the diaphragm (13) is opposed, and
a valve seat (15) formed around an opening at one end of the first flow passage (7),
the shut-off valve (8) being opened and closed by allowing the diaphragm (13) to approach and separate from this valve seat (15), wherein
a groove portion (18) is formed in the inner surface of the valve chamber (9) at a periphery of the valve seat (15) and is provided with an groove outlet/inlet (19) which is opened in an area larger than a circle having a diameter of a groove width (w), and
the second flow passage (10, 23) communicates with the valve chamber (9) through the groove outlet/inlet (19) and the groove portion (18) in the mentioned order.

2: The valve assembly as set forth in claim 1, wherein at least part of the groove outlet/inlet (19) is opened into a groove side surface (20).

3: The valve assembly as set forth in claim 1, wherein at least a portion of the groove outlet/inlet (19) side of the second flow passage (10, 23) is inclined with respect to an axis (22) of the first flow passage (7).

4: The valve assembly as set forth in claim 1, wherein the groove portion (18) has a groove bottom surface (21) which increases its depth toward the groove outlet/inlet (19).

5: The valve assembly as set forth in claim 1, wherein the second flow passage (10, 23) communicates with the groove portion (18) from a tangent direction.

6: The valve assembly as set forth in claim 1, wherein the largest depth (h) of the groove portion (18) is of a dimension not less than 30% of the groove width (w).

7: The valve assembly as set forth in claim 1, wherein the largest depth (h) of the groove portion (18) is of a dimension at least equal to the minimum diameter (d) of the first flow passage (7).

8: The valve assembly as set forth in claim 2, wherein at least a portion of the groove outlet/inlet (19) side of the second flow passage (10, 23) is inclined with respect to an axis (22) of the first flow passage (7).
